(19) United States
(12) Patent Application Publication
(10) Pub. No.: US 2016/0147945 A1
(43) Pub. Date: May 26, 2016

(54) System and Method for Providing Secure Check of Patient Records

(71) Applicant: IMS Health Incorporated, Danbury, CT (US)

(72) Inventors: John MacCarthy, Bourne End (GB); Stephen Hill, London (GB)

(21) Appl. No.: 14/554,475

(22) Filed: Nov. 26, 2014

(51) Int. Cl. G06F 19/00; H04L 29/06; G06F 21/62

(52) U.S. Cl. CPC G06F 19/322; G06F 21/6254; H04L 63/0428; G06Q 2220/10

(57) ABSTRACT

Methods and systems are described for performing secure checks of details of patient health records stored across multiple healthcare institutions without disclosing identifying details of the patient in transit and without compromising commercial confidentiality. One method includes receiving an encrypted and de-identified request for health record information associated with an anonymized patient identifier from a collection computing system. The method includes obtaining patient data associated with the anonymized patient identifier from a set of source computing systems based on matching the anonymized patient identifier received from the collection computing system with the anonymized patient identifiers received from the set of source computing systems. The method includes generating a cumulative report based on analyzing the patient data obtained from the set of source computing systems and sending the cumulative report in response to the request for health record information associated with the anonymized patient identifier to the collection computing system.

### CROSS REFERENCE TO RELATED APPLICATIONS

This application is related to U.S. Non-Provisional application Ser. No. 14/494,420, entitled “System and Method for the De-identification of Healthcare Data,” filed on Sep. 23, 2014, which is incorporated herein by reference in its entirety.

### BACKGROUND

An increasing amount of patient healthcare data regarding diagnosis and treatment is being electronically entered and recorded. For example, a healthcare provider may electronically submit healthcare data for the purpose of receiving payment for services rendered. The healthcare data may be transmitted amongst healthcare providers, clearinghouses and/or providers of electronic data interchange, and/or insurance companies. Such healthcare data may include standardized codes to describe diagnoses made, services performed, or products used.

However, regulations in various countries, such as the Health Insurance Portability and Accountability Act of 1996 (HIPAA) in the U.S., restrict covered entities from disclosing protected health information (“PHI”). The disclosure of PHI is regulated because it is healthcare data with personally identifiable information (“PII”). Many data sources would be considered covered entities because the data sources produce information that may contain PHI, and PHI through its associated PII can be used to positively identify the patient with whom the healthcare data is related.

Typically patient healthcare data are stored across hundreds or thousands of different organizations (e.g., hospitals, clinics, doctor's offices, pharmacy outlets, insurance companies, etc.) over time. In many cases, it is necessary for one healthcare institution to obtain healthcare information associated with a patient from variety of organizations before performing a service for the patient. In such cases, it is very resource and time intensive for one healthcare institution to obtain such patient healthcare data from hundreds or thousands of organizations. Additionally, in some instances, some organizations do not readily share patient data with other organizations in order to prevent sharing medically sensitive and commercially sensitive data and to prevent violation of patient privacy laws. This often leads to poor exchange of healthcare information across different healthcare organizations and can thus compromise the quality of healthcare services provided to a patient.

Accordingly, a need exists for methods and systems for securely exchanging healthcare data stored across multiple healthcare institutions without disclosing identifying details of the patient and without compromising commercial confidentiality.

### SUMMARY

The present disclosure relates to computer-implemented methods, software, and systems for performing secure checks of details of patient health records stored across multiple healthcare institutions without disclosing identifying details of the patient in transit and without compromising commercial confidentiality. One method includes generating an encrypted request for health record information for a patient and an encrypted anonymized patient identifier at a first computing system (de-identification). The method includes receiving the encrypted and de-identified request for health record information associated with an anonymized patient identifier from a computing device associated with a first computing system. The method includes obtaining patient data associated with the anonymized patient identifier from a set of second computing systems based on matching the anonymized patient identifier received form the first computing system with the anonymized patient identifiers received from the set of second computing systems. The method includes generating a cumulative report based on analyzing the de-identified patient data obtained from the set of second computing systems and sending the de-identified cumulative report in response to the request for health record information associated with the anonymized patient identifier to the first computing system. The method further includes linking at the first computing system, the cumulative report with patient identification information that can retrieved from the anonymized patient identifier (re-identification).

In one aspect, a computer-implemented method includes receiving, by a computing system, a record of healthcare data, wherein the record includes patient identifying information (PII) associated with one or more persons to whom the healthcare data pertains. The computing system analyzes the PII to identify a type and a content of the PII included in the record of healthcare data. The computing system extracts portions of PII included in the accessed record of healthcare data. The computing system encrypts the extracted portions of PII. Based on one or more business rules and the analysis of the PII, the computing system determines a number of concatenated strings to generate. At least a portion of the one or more business rules indicate a relationship between the number of concatenated strings and the type and the content of the PII included in the record of healthcare data. Based on the one or more business rules, the computing system concatenates a plurality of the encrypted portions of PII into the determined number of concatenated strings. At least a portion of the one or more business rules indicate which encrypted portions of PII to concatenate into each concatenated string and an ordering of the encrypted portions of PII within each concatenated string. The computing system creates a corresponding number of hashed tokens to the determined number of concatenated strings by applying one or more hashing functions to each of the determined number of concatenated strings. The computing system de-identifies the accessed record by removing data designated as PII. The computing system stores the corresponding number of hashed tokens in association with the de-identified record.

Other implementations of these aspects include corresponding computing systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by a data processing apparatus, cause the apparatus to perform the actions.

These and other aspects may each optionally include one or more of the following features. The one or more business rules may be specific to one of a plurality of geographic regions, and business rules specific to at least two of the plurality of geographic regions may indicate a different relationship between the number of concatenated strings and the type and the content of the PII included in the record of healthcare data. Additionally or alternatively, the relationship between the number of concatenated strings and the type and the content of the PII included in the record of healthcare data may indicate that the number of concatenated strings is greater when certain types of PII are not included in the record than when the certain types of PII are included in the record.

The method may further include transmitting the multiple hashed tokens and the de-identified record to a collection computing system that utilizes the multiple hashed tokens to longitudinally link the de-identified record with one or more other de-identified records containing healthcare data pertaining to the one or more persons.

Creating the multiple hashed tokens may include, for each of the determined number of concatenated strings, appending a portion of an encryption key to the concatenated string, creating an intermediary token by applying a first hashing function to the particular concatenated string that includes the appended portion of the encryption key, appending another portion of the encryption key to the intermediary token, and creating a hashed token by applying a second hashing function to the intermediary token that includes the appended other portion of the encryption key. The first hashing function may be an AES-family hashing function and/or the second hashing function may be an SHA-family hashing function.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for de-identifying healthcare data.

FIG. 2 is a block diagram illustrating an example system for providing secure transfer of patient records across multiple computing systems in a network of healthcare institutions.

FIG. 3 is a flow chart of an example process 300 for using an intermediary computing device to share secure patient healthcare data with source and collection computing systems in a network of healthcare institutions.

FIG. 4 is a message flow diagram illustrating a method for sharing secure patient healthcare data across multiple source and collection computing devices in a network of healthcare institutions, according to an embodiment.

FIG. 5 is a block diagram of an example graphical user interface that may be used for sending a request for patient health record information and receiving encrypted and de-identified patient data.

Like reference numbers and designations in the various drawings indicate like elements.

### DETAILED DESCRIPTION

The present disclosure relates to computer-implemented methods, software, and systems for performing secure checks of details of patient health records stored across multiple healthcare institutions without disclosing identifying details of the patient in transit and without compromising commercial confidentiality. One method includes generating an encrypted request for health record information for a patient and an encrypted anonymized patient identifier at a first computing system (de-identification). The method includes receiving the encrypted and de-identified request for health record information associated with an anonymized patient identifier from a computing device associated with a first computing system. The method includes obtaining patient data associated with the anonymized patient identifier from a set of second computing systems based on matching the anonymized patient identifier received form the first computing system with the anonymized patient identifiers received from the set of second computing systems. The method includes generating a cumulative report based on analyzing the de-identified patient data obtained from the set of second computing systems and sending the de-identified cumulative report in response to the request for health record information associated with the anonymized patient identifier to the first computing system. The method further includes linking at the first computing system, the cumulative report with patient identification information that can retrieved from the anonymized patient identifier (re-identification).

For illustration purposes, the various implementations described herein will be described with regard to patient healthcare data that may be created, stored, or transmitted by healthcare professionals (e.g., doctors, nurses, technicians, and/or pharmacists), medical facilities (e.g., doctor's offices, hospitals, clinics, and/or nursing homes), healthcare service providers (e.g., insurance companies), and/or retail outlets (e.g., pharmacies). However, the described secure patient record transfer system is equally applicable to the de-identification and re-identification of all types of private, personal data and the entities that create, store, or transmit that data. Additionally or alternatively, the described secure patient record transfer system may be configured to facilitate data de-identification and re-identification in other types of software or hardware (e.g., advertising software or hardware).

In some implementations, the described de-identification system is configured to protect and de-identify healthcare data by converting elements of PII into one or more anonymous linking tokens that facilitate tracking and analysis of the healthcare data by uniquely identifying the healthcare data while preserving the anonymity of the individual associated with the healthcare data. For example, the described de-identification system may form the anonymous linking tokens from predetermined portions of PII contained in a record of healthcare data and replacing the PII in that record of healthcare data with the anonymous linking tokens. The healthcare data is “de-identified” by removing all information considered to be PII. The anonymous linking tokens are then appended to the healthcare data. The use of multiple anonymous linking tokens based on varying combinations of PII increases the likelihood of linking the de-identified healthcare data with other de-identified healthcare data associated with the same individual patient.

The anonymous linking tokens allow for linking or associating of healthcare data for a particular person even though the healthcare data has no direct identifiers, comes from different data sources, and was created at different times. In some implementations, the de-identified data with the appended anonymous linking tokens is sent to one or more data warehouses that can join several data files at the de-identified patient-specific level. At the one or more data warehouses, the anonymous linking tokens can be replaced with or augmented by an indexing tag. By replacing the anonymous linking tokens, which is based on portions of PII, with the indexing tag, the healthcare data is further de-identified because it contains no PII, and the anonymous linking tokens, which are based on portions of PII, are replaced by the indexing tag. Data can then be linked (i.e., associated with other data related to the same person) and clustered without using PII or any data based on PII. By de-identifying the healthcare data in this manner, the de-identification system supports the detailed analysis of patient-level healthcare data while complying with regulations governing the storage and transmission of patient healthcare data.

In some implementations, the de-identification system is configured to handle de-identification in a number of different countries or other geographical regions, complying with the local regulations governing the storage and transmission of patient healthcare data. For example, the de-identification system may be configured to designate various fields with a record of healthcare data as PII for purposes of de-identification depending on the regulations for the relevant jurisdiction(s). Additionally or alternatively, the de-identification system may rely upon different portions of PII in creating the one or more anonymous linking tokens, depending on the regulations for the relevant jurisdiction(s). Additionally or alternatively, the de-identification system may employ varying encryption algorithms depending on the regulations for the relevant jurisdiction(s).

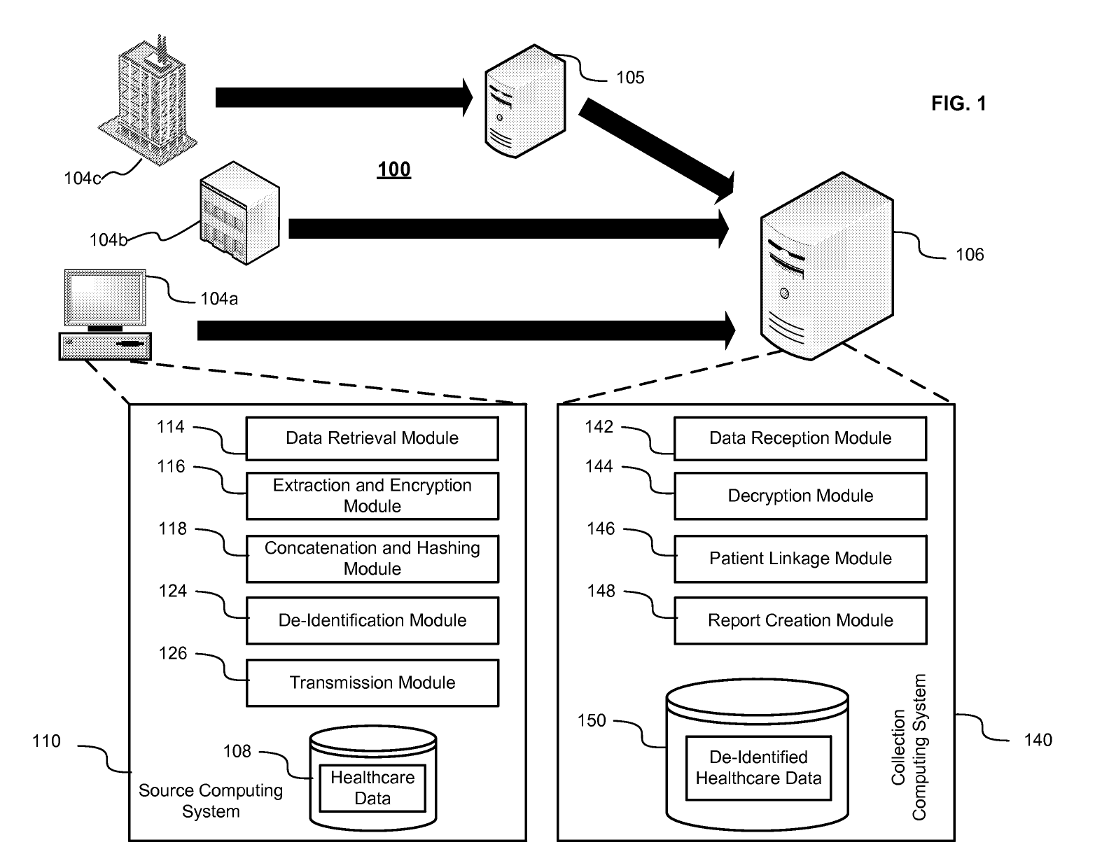

FIG. 1 is a block diagram illustrating an example system for de-identifying healthcare data. The example healthcare de-identification system 100 illustrated in FIG. 1 is shown as including a source computing system 110 and a collection computing system 140. Each of the source computing system 110 and collection computing system 140 may be implemented on one or more computers. The implementation shown in FIG. 1 illustrates multiple instances of the source computing system 110, each being implemented across one or more computers. For example, the source computing system 110 may be implemented on a computer 104a at a doctor's office, across a computer system 104b at a clinic or a hospital, and/or across a computer system 104c at an insurance company. Additionally or alternatively, the source computing system 110 or a portion thereof may also be implemented on one or more computer systems 105 located at one or more trusted third-party intermediaries. The collection computing system 140 may similarly be implemented on one or more computer systems 106 at one or more sites that collect and analyze de-identified healthcare data.

Though the healthcare de-identification system 100 is illustrated as including a source computing system 110 and a collection computing system 140, the healthcare de-identification system 100 may be logically divided into more or fewer components and implemented at more or fewer locations while still performing the same or similar processing functions, as will be described in greater detail below. For example, where regional privacy laws permit and proper agreements are in place, the source computing system 110 may be implemented entirely at trusted third party intermediaries to which various sources of healthcare data (e.g., healthcare professionals, medical facilities, healthcare service providers, and/or retail outlets) send healthcare data using secure communication means (e.g., secure FTP).

The source computing system 110 will be described as including one or more storage devices 108 that store healthcare data. The stored healthcare data may be input by a user (e.g., a healthcare professional) of the computer or computer system on which the source computing system 110 is implemented. Additionally or alternatively, the stored healthcare data may be received from another computer or computer system. For example, the computer system 104b located at a clinic may include multiple computers at which users enter healthcare data. The source computing system 110 may be implemented on one or more of these multiple computers. For example, in some implementations, each computer at which healthcare data is entered may implement an instance of source computing system 110. Additionally or alternatively, the source computing system 110 may be implemented at one of the multiple computers located at the clinic and the other computers may send input healthcare data to the computer implementing the source computing system 110.

The healthcare data stored in the one or more storage devices 108 is data that pertains to the health, condition, disease, treatment, and other similar information of a particular person or patient. The healthcare data may include personal identifying information (PII) for identifying the person or patient to whom the healthcare data pertains. The healthcare data can include, but is not limited to, diagnoses, patient visit information, drug data, procedure data, prescription specific information, laboratory data, data feeds, test orders, test results, consultant's report, and other similar data related to or associated with the health of a person. In some implementations, the healthcare data may include standardized codes to describe the diagnoses made, services performed, products used, and other relevant information.

For ease of explanation, the following disclosure may refer to healthcare data with regard to a record. However, the term record is not meant to limit the content, format, quantity, or quality of healthcare data or the manner in which it is provided, stored, or processed. Rather, a record is simply being used to refer to a discrete quantity of healthcare data that contains PII identifying one or more persons to whom the healthcare data corresponds. In some implementations, the healthcare data may be provided on a standard form, such as CMS-1500/837p, CMS-1450/uB-92/uB-04/837i, NCPDP 5.1, or other similar forms. However, the healthcare data may be provided or stored in one or more data structures that take any standard or non-standard format. In some implementations, for example, the healthcare data may be contained in healthcare insurance claims from pharmacies and physicians. Moreover, the term record does not limit the source of the healthcare data. In some implementations, for example, the healthcare data may be provided directly by a healthcare provider or provided by a central clearinghouse, a payer, a pharmacy benefits manager, or other similar sources of health care data.

The PII contained in the healthcare data may come in various forms. For example, PII may include, but is not limited to, direct identifiers, such as names, elements of addresses, birth dates, social security numbers, insurance policy numbers, and/or license numbers. Additionally or alternatively, PII may include indirect identifiers that may not, on their own, identify a person, but that may, in combination with other information, be used to identify a person. Whether or not one or more portions of healthcare data contained in a record are considered to be PII may be dictated by legal rules and regulations, privacy policies, and/or the individuals and organizations that create, provide, store, or process healthcare data.

In some implementations, the healthcare de-identification system 100 is provided with business rules that identify which portions of healthcare data contained in a record are considered to be PII and how to handle that PII. These PII business rules may be static or dynamic and may take any form. The term business rule is not meant to be limiting, and simply refers to any data, logic, or instruction that informs the handling of PII. The PII business rules may, for example, be provided to the healthcare de-identification system 100 by an individual or entity that designs, builds, implements, operates, and/or maintains the healthcare de-identification system 100. For example, the PII business rules may be hardcoded into the healthcare de-identification system 100 by an individual or entity that designs the healthcare de-identification system 100. Additionally or alternatively, the healthcare de-identification system 100 may be configured to obtain PII business rules from one or more sources. For example, the healthcare de-identification system 100 may be configured to obtain PII business rules or information relevant to PII business rules from government organizations that disseminate information regarding rules, regulations, and/or statutes governing healthcare data.

In some implementations, the record itself may contain data that identifies which portions correspond to PII. Additionally or alternatively, a user or administrator of the healthcare de-identification system 100 may identify which portions of a record correspond to PII. For example, a healthcare professional may identify portions of healthcare data as being PII as the healthcare professional enters healthcare data into the healthcare de-identification system 100. In another example, a healthcare professional or other user may designate portions of healthcare data as PII while reviewing previously stored healthcare data.

For illustrative purposes, the source computing system 110 will be described as including a data retrieval module 114, an extraction and encryption module 116, a concatenation and hashing module 118, a de-identification module 124, and a transmission module 126. However, the source computing system 110 may be any computing platform capable of performing the described functions. For example, the source computing system 110 may include one or more computing systems that may include hardware, software, or a combination of both for performing the described functions. Moreover, the data retrieval module 114, extraction and encryption module 116, concatenation and hashing module 118, de-identification module 124, and transmission module 126 may be embodied together or separately in hardware and/or software. Though the data retrieval module 114, extraction and encryption module 116, concatenation and hashing module 118, de-identification module 124, and transmission module 126 will be described as each carrying out certain functionality, the described functionality may be performed by one or more other modules in conjunction with or in place of the described module. In some implementations, the data retrieval module 114, extraction and encryption module 116, concatenation and hashing module 118, de-identification module 124, and transmission module 126 may each be implemented across more than one computer or computer system. For example, in the computer system 104b located at a clinic, each computer included in the computer system 104b may implement one or more of the data retrieval module 114, extraction and encryption module 116, concatenation and hashing module 118, de-identification module 124, and transmission module 126 while a single central computer of the computer system 104b may implement the other modules.

For illustrative purposes, the collection computing system 140 will be described as including a data reception module 142, a decryption module 144, a patient linkage module 146, and a report creation module 148. However, the collection computing system 140 may be any computing platform capable of performing the described functions. For example, collection computing system 140 may include one or more computing systems that may include hardware, software, or a combination of both for performing the described functions. Moreover, the data reception module 142, decryption module 144, patient linkage module 146, and report creation module 148 may be embodied together or separately in hardware and/or software. Though the data reception module 142, decryption module 144, patient linkage module 146, and report creation module 148 will be described as each carrying out certain functionality, the described functionality may be performed by one or more other modules in conjunction with or in place of the described module. In some implementations, the data reception module 142, decryption module 144, patient linkage module 146, and report creation module 148 may each be implemented across more than one computer or computer system. For example, in the computer system 106 located at a collection site, each computer included in the computer system 106 may implement one or more of the data reception module 142, decryption module 144, patient linkage module 146, and report creation module 148.

The collection computing system 140 will also be described as including one or more storage devices 150 that store de-identified healthcare data. The one or more storage devices 150 may be configured to store de-identified healthcare data received from one or more source computer system 110. Additionally or alternatively, the one or more storage devices 150 may be configured to store de-identified healthcare data that has been longitudinally linked by patient linkage module 146. Additionally or alternatively, the one or more storage devices 150 may be configured to store one or more reports created by the report creation module 148.

Note that the various modules and their functionalities for the source computing system 110 and the collection computing system 140, respectively, can be interchangeable. In other words, in some instances, the data retrieval module 114, an extraction and encryption module 116, a concatenation and hashing module 118, a de-identification module 124, and a transmission module 126 can be part of the collection computing system 140 and data reception module 142, a decryption module 144, a patient linkage module 146, and a report creation module 148 can be part of the source computing system 110.

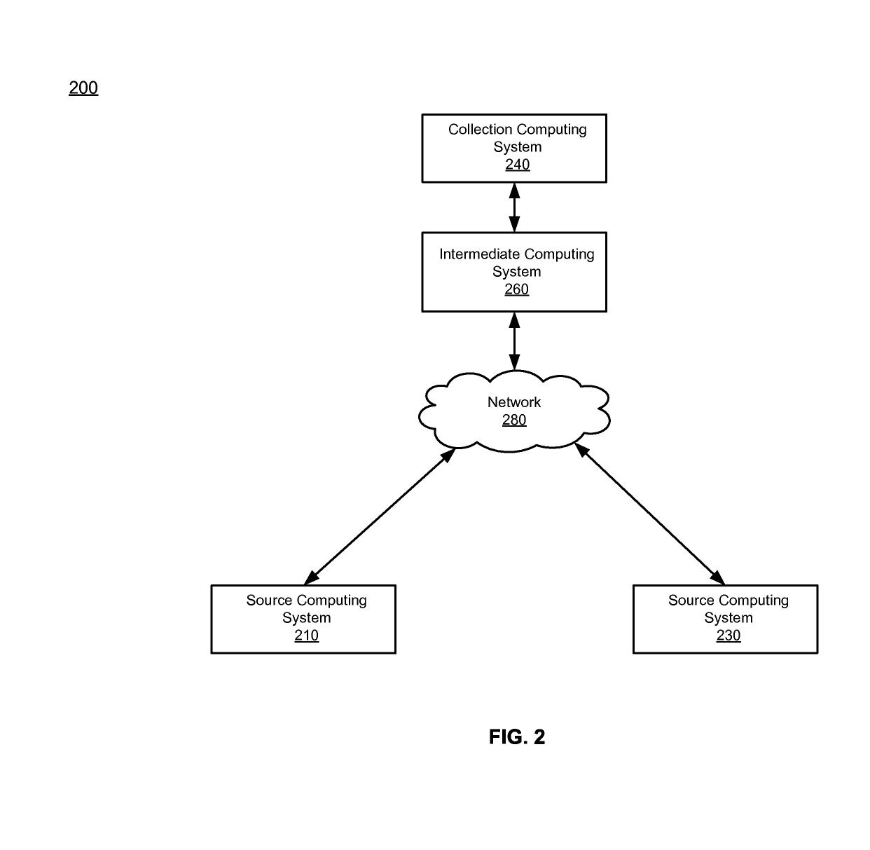

The operation of the healthcare de-identification system 100 illustrated in FIG. 1 will now be described with regard to FIGS. 2-5. However, the processes described with regard to FIGS. 2-5 may be implemented on any computing system(s).

FIG. 2 is a block diagram illustrating an example system for providing secure transfer of patient records across multiple computing systems in a network of healthcare institutions. The secure patient record transfer system 200 includes a collection computing system 240, an intermediate computing system 260, a network 280 and source computing systems 210 and 230. The network 280 can be any type of network (e.g., a local area network (LAN), a wide area network (WAN), a virtual network, and a telecommunications network) implemented as a wired network and/or wireless network. As described in further detail herein, in some configurations, for example, the source computing systems 210 and 230 can be operably coupled to the intermediate computing system 260 via an intranet, an Internet Service Provider (ISP) and the Internet, a cellular network (e.g., network 280), and/or the like.

In some instances, the source computing devices 210 and 230 can include, for example, a server or a host machine such as for example, a web server, an application server, a proxy server, a telnet server, and/or a file transfer protocol (FTP) server. In other instances, source computing systems 210 and 230 can also include a personal computing device such as a desktop computer, a laptop computer, a personal digital assistant (PDA), a standard mobile telephone, a tablet personal computer (PC), and/or so forth. The implementation shown in FIG. 2 illustrates the source computing systems 210 and 230 being implemented across one or more computers. For example, the source computing systems 210 and 230 may be implemented on a computer at a doctor's office, across a computer system at a clinic, across a computer system at a pharmaceutical retail outlet, across a computer system at an insurance company, and/or the like.

The collection computing system 240 can include, for example, a server or a host machine such as for example, a web server, an application server, a proxy server, a telnet server, and/or a file transfer protocol (FTP) server. In other instances, the collection computing device 240 can also include a personal computing device such as a desktop computer, a laptop computer, a personal digital assistant (PDA), a standard mobile telephone, a tablet personal computer (PC), and/or so forth. The collection computing system 240 may be implemented on a computer at a doctor's office, across a computer system at a clinic, across a computer system at a pharmaceutical retail outlet, across a computer system at an insurance company, and/or the like.

The intermediate computing system 260 can include, for example, a server or a host machine such as for example, a web server, an application server, a proxy server, a telnet server, and/or a file transfer protocol (FTP) server. The intermediate computing system 260 may be implemented on one or more computer systems at one or more sites that can collect and analyze de-identified and encrypted healthcare data. Additionally or alternatively, the intermediate computing system 260 or a portion thereof may also be implemented on one or more computer systems located at one or more trusted third-party intermediary organization that is in communication with the healthcare institution associated with the source computing systems 210 and 230 and the collection computing system 240. The intermediate computing system 260 routes requests or queries based on the anonymous linking tokens (i.e., anonymized patient identifiers) and thus avoids the risk of patient identification in data transit. It follows that the intermediate computing system 260 cannot be co-located with a collection computing system 240 or the source computing system 210 and 230 that holds the actual patient ID linked to the anonymized token (i.e., the anonymized identifier).

Though the secure patient record transfer system 200 is illustrated in FIG. 2 as including one collection computing system 240, one intermediate computing system 260 and two source computing systems 210 and 230, the secure patient record accessing system 200 may be logically divided into more or fewer components and implemented at more or fewer locations while still performing the same or similar processing functions, as will be described in greater detail below. For example, where regional privacy laws permit and proper agreements are in place, the source computing systems 210 and/or 230 may be implemented entirely at trusted third party intermediaries to which various sources of healthcare data (e.g., healthcare professionals, medical facilities, healthcare service providers, and/or retail outlets) send healthcare data using secure communication means (e.g., secure FTP).

In some instances, the collection computing system 240 can receive a request signal for a healthcare service to be provided to a patient from a transaction or point-of-sales computer system located in the same healthcare institution. The request for the healthcare service can be, for example, a request to fill prescriptions for a patient, a request to determine whether a patient is due for a refill of the prescription, a request for performing a medical procedure on a patient, a request for patient laboratory test records, and/or the like. In such instances, the collection computer device 240 can encrypt the identity of the patient and the data associated with the healthcare service requested.

In such instances, the collection computing system 240 can implement one or more different hash function generation techniques to generate the hash value or (a set of) hash strings of the patient identity information (PII) included in the request signal to define an anonymized patient identifier and the data included in the request signal related to the healthcare service request to define an encrypted patient data. In such instances, the collection computing system 240 can apply one or more hashing functions to each of the hash strings to create a corresponding number of hashed tokens. Although the number and type of hashing functions used by the collection computing system 240 to hash each of the concatenated strings of PII can vary, the number and type of hashing functions used by the collection computing system 240 must be consistent with the number and type of hashing functions used by the source computing systems 210 and 230. Moreover, another cryptographic primitive, such as a block cipher, can be used instead of a hashing function. However, the hash function may be preferred because it generally has no inverse function that can recover the input from the hash function's output. A hash function maps a bit string of arbitrary length to another bit string of fixed length. Hash functions include Ripe-MD, Whirlpool, Haval, MD4, MD5, and the SHA group of hash functions. Preferably, the collection computing system 240 utilizes the SHA-2 family, in particular, SHA-256 which creates 256 bit hashes. The SHA family of hash functions was designed by the National Institute of Standards and Technology and is a Federal Information Processing Standard, as described by Federal Information Processing Standards Publication 180-2, dated Aug. 1, 2002. Federal Information Processing Standards Publication 180-2 also provides an algorithm and examples for implementing an SHA-256 hash function. The collection computer device 240 can send the encrypted patient data that is associated with the anonymized patient identifier to the intermediate computing system 260.

After receiving the encrypted and de-identified patient data that is associated with the anonymized patient identifier, the intermediate computing system 260 can determine the access rights of the collection computing system 240 to make the request for health record information associated with the anonymized patient identifier. Such determination can be made by, for example, ascertaining whether an identifier (e.g., an IP address or a MAC address) of the device in collection computing system 240 sending the request signal is associated with a legitimate healthcare service provider, and whether the collection computing system 240 is configured to send and/or receive encrypted and de-identified patient data from the intermediate computing system 260. After establishing the rights of the collection computing system 240 to make the request for health record information associated with the anonymized patient identifier, the intermediate computing system 260 can send an encrypted signal to the set of source computing systems 210 and 230 (e.g., via the network 280) that requests for healthcare data associated with the anonymized patient identifier. The intermediate computing system 260 identifies the set of source computer systems 210 and 230 (from among all source and collection computing systems in a network of healthcare institutions) to send the request for health record information associated with the anonymized patient identifier based on the periodic, substantially periodic or random updates of new anonymized identifiers of new patients and modified anonymized identifiers of existing patients received from the source computer systems 210 and 230.

Upon receiving the request for healthcare data associated with the anonymized patient identifier, the source computing systems 210 and 230 can perform a lookup operation on a database or a table stored either in the source computing systems 210 and 230 or operably coupled to the source computing systems 210 and 230. In such instances, the source computing systems 210 and 230 can match the anonymized patient identifier in the data received from the intermediate computer system 260 with a set of anonymized patient identifiers stored in the database in the source computing devices 210 and 230. If a match is found, the source computing devices 210 and 230 can retrieve the stored encrypted and de-identified patient data associated with the matched anonymized patient identifier. The source computing devices 210 and 230 can send the encrypted and de-identified patient data associated with the matched anonymized patient identifier to the intermediate computing system 260 (e.g., via the network). Such encrypted patient data can include, for example, data associated with each prescription of the pharmaceutical product filled at the health services provider associated with the source computing system 210 and/or 230, a type of the pharmaceutical product prescribed, the location of the source computing system 210 and/or 230, the data and time a prescription was dispensed, an amount of the pharmaceutical product that was prescribed, the price of the pharmaceutical product prescribed, the dosage of the pharmaceutical product prescribed, and/or the like.

The intermediate computing system 260 can receive the encrypted and de-identified patient data associated with the anonymized patient identifier from the set of source computing systems 210 and/or 230. The intermediate computing system 260 can analyze the encrypted and de-identified patient data associated with the anonymized patient identifier from the set of source computer systems 210 and/or 230 to generate an encrypted cumulative report. The intermediate computing system 260 can send the encrypted cumulative report in response to the request for health record information associated with the anonymized patient identifier, to the collection computer system 240.

The collection computing system 240 can decrypt the received encrypted and de-identified cumulative report based on one or more business rules and decryption techniques. For example, the collection computing system 240 can compare the number of hashed tokens received with the encrypted and de-identified healthcare record with other hashed tokens associated with previously received and stored de-identified healthcare records. The collection computer system 240 can attempt to find the most likely match between the hashed tokens received with the encrypted and de-identified healthcare record (i.e., received from the intermediate computer system 260) and the previously received hashed tokens in order to link de-identified healthcare records that correspond to the same patient(s) associated with the anonymized patient identifier. In some implementations, de-identified healthcare records that correspond to the same patient(s) are stored in association with an anonymized profile corresponding to the patient(s).

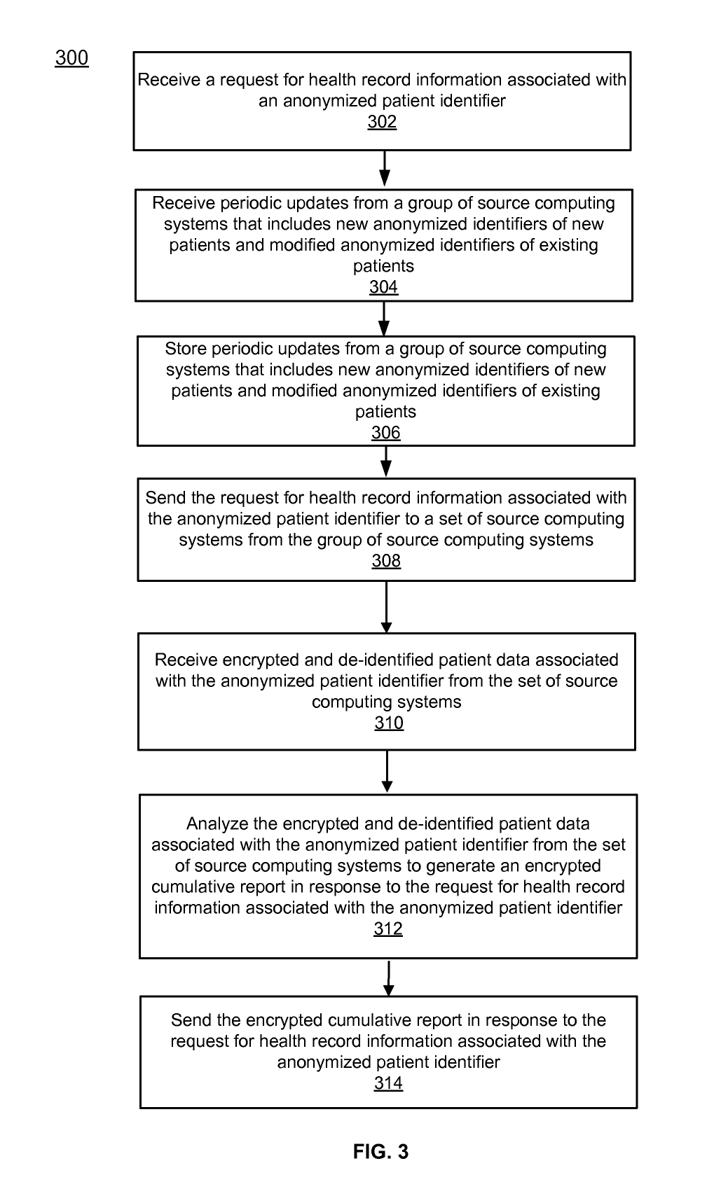

FIG. 3 is a flow chart of an example process 300 for using an intermediary computing device to share secure patient healthcare data with source and collection computing systems in a network of healthcare institutions. The process 300 includes receiving a request for health record information associated with an anonymized patient identifier by, for example, an intermediate computing system 260, at 302. The request for health record information associated with an anonymized patient identifier can be sent from, for example, a collection computing system 240. As described above, the collection computing system may be implemented, for example, on a computer at a doctor's office, across a computer system at a clinic or a hospital, across a computer system at an insurance company, across a computer system at a pharmaceutical retailer, and/or the like.

In some configurations, the collection computing system 240 can receive or access a record of healthcare data of a patient (e.g., from a point-of-sales device) that includes a patient identifying information (PII). The collection computing system 240 can identify and extract multiple portions of the PII included in the record, encrypt the extracted portion of the PII (e.g., using a key-based encryption method such as RSA, DSA, or AES), concatenate the multiple portions of the extracted PII into a specific number of strings based on one or more business rules, and apply one or more hashing functions to each of the specific number of strings to create a corresponding number of hashed tokens that can define the anonymized patient identifier for the patient.

At 304, periodic updates from a group of source computing systems 210 and/or 230 that includes new anonymized identifiers for new patients (or persons) and modified anonymized identifiers for existing patients (or persons) can be received at, for example, the intermediate computing system 260. At 306, the periodic updates from a group of source computing systems 210 and/or 230 that includes new anonymized identifiers for new patients (or persons) and modified anonymized identifiers for existing patients (or persons) can be stored by the intermediate computing system at, for example, a database located in the intermediate computing system 260 and/or a database stored on a remote device that is operably coupled to the intermediate computing system 260.

At 308, the request for health record information associated with the anonymized patient identifier is sent to a set of source computing systems from the group of source computing systems by, for example, the intermediate computing system. As described above, the intermediate computing system 260 can identify a set of source computing systems 210 and 230 (from among all source computing systems in a network of healthcare institutions) to send the request for health record information based on matching the received anonymized patient identifier to the stored anonymized identifiers of new patients and modified anonymized identifiers of existing patients that was received from the source computing systems 210 and 230. This can be a computationally efficient and a time saving step as the intermediate computing system 260 can select a defined subset of the relevant source computing systems from all the source computing systems in the network of healthcare institutions to send the request for health record information associated with the anonymized patient identifier.

At 310, a set of encrypted and de-identified patient data associated with the anonymized patient identifier from the set of source computing systems is received by, for example, the intermediate computing system 260. As described above, the encrypted and de-identified patient data can include, for example, data associated with each prescription of the pharmaceutical product served from the health services provider associated with the source computer device 210 and/or 230, a type of the pharmaceutical product prescribed, the location of the source computer device 210 and/or 230, the data and time a prescription was dispensed, an amount of the pharmaceutical product that was prescribed, the price of the pharmaceutical product prescribed, the dosage of the pharmaceutical product prescribed, and/or the like.

At 312, the encrypted and de-identified patient data associated with the anonymized patient identifier from the set of source computing systems is analyzed to generate an encrypted cumulative report for the request for health record information associated with the anonymized patient identifier at, for example, the intermediate computing device 260. The analysis of the encrypted and de-identified patient data associated with the anonymized patient identifier includes determining, the validity of the encrypted and de-identified patient data received from each source computing system from the set of source computing systems by, for example, analyzing a security token and a time stamp associated with the encrypted and de-identified patient data received from the set of source computing systems; and aggregating the encrypted and de-identified patient data associated with the anonymized patient identifier from the set of source computing systems. The aggregation process can provide a robust tabulation of the different entries in the encrypted cumulative report for the request for health record information associated with the anonymized patient identifier.

At 314, the encrypted cumulative report for the request for health record information associated with the anonymized patient identifier is sent by, for example, the intermediate computing system 260 to, for example, the collection computing system 240. The collection computing system 240 can de-crypt the encrypted cumulative report and the anonymized patient identifier to retrieve the patient health record and the PII of the patient, respectively. The collection computing system 240 can link the cumulative report to the PII of the patient and send the cumulative report in response to the request for health record information associated with the patient identifying details to, for example, a transaction computer (i.e., a point-of-sales computer or tablet) that originated the request for the health record information for the patient.

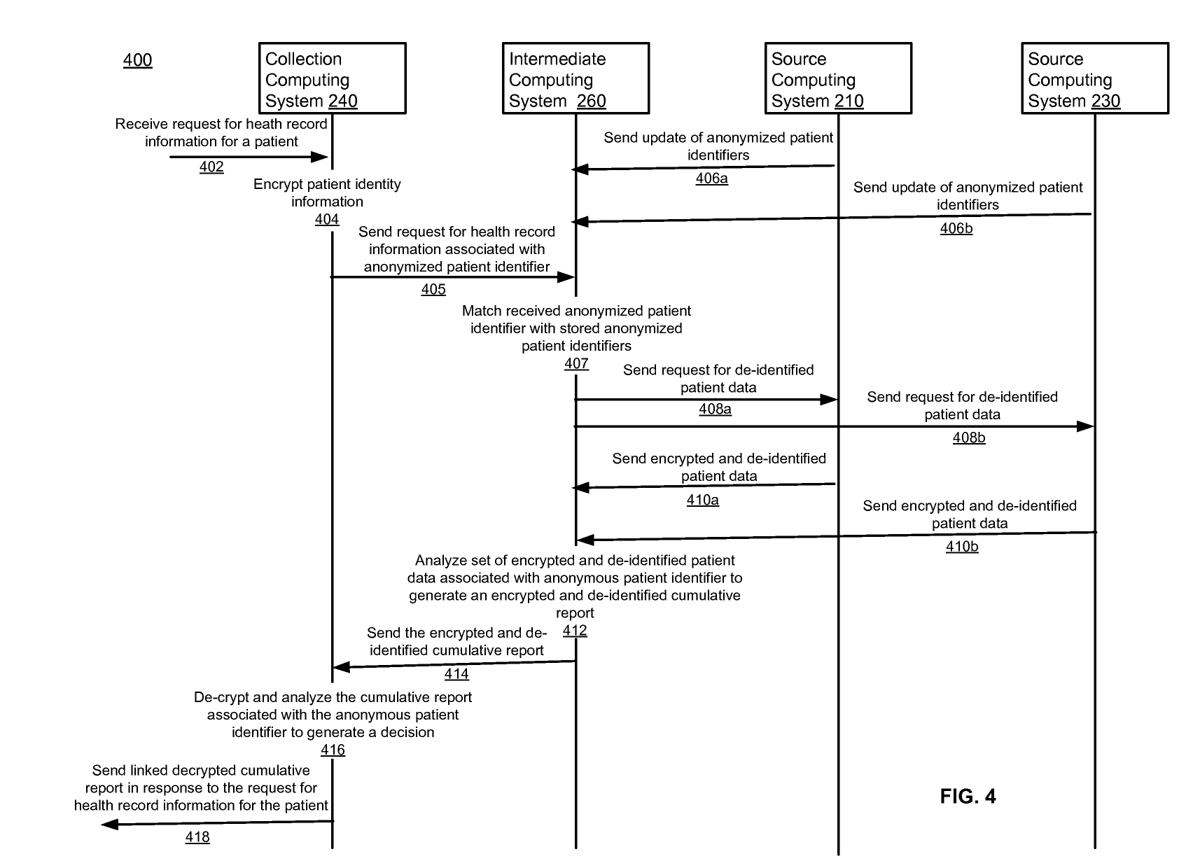

FIG. 4 is a message flow diagram illustrating a method for sharing secure patient healthcare data across multiple source and collection computing devices in a network of healthcare institutions, according to an embodiment. The method 400 includes the collection computing system 240 receiving a request for health record information for a patient associated with patient identifying information (PII) from a transaction device (e.g., a point-of-sales computer or tablet), at 402. The collection computing system 240 and the transaction device are located in or associated with the same healthcare institution (e.g., a doctor's office, a clinic, a hospital, a pharmacy, an insurance company, etc.). In some instances, the collection computing system 240 and transaction device are not co-located and may not be in a healthcare institution. For example, one use case is the provision of prescription records to a patient. In this case, the transaction device could be the patient's mobile phone that runs a secure healthcare application. In such instances, the application would send the request to a collection computing system 240 located at a trusted third party institution that is most likely acting as a business associate to pharmacies.

The received request for health record information for a patient includes patient identifying information (PII) such as, for example (but not limited to), direct identifiers, such as names, elements of addresses, birth dates, social security numbers, insurance policy numbers, and/or license numbers. Additionally or alternatively, PII may include indirect identifiers that may not, on their own, identify a patient (or person), but that may, in combination with other information, be used to identify a patient (or person). Whether or not one or more portions of health data contained in a health record are considered to be PII may be dictated by legal rules and regulations, privacy policies, and/or the individuals and organizations that create, provide, store, or process healthcare data.

At 404, the collection computing system 240 encrypts the patient identifying information (PII) in to generate an anonymized patient identifier. The collection computing system 240 can identify and extract multiple portions of PII included in the request signal. In some implementations, as part of operation 404, the collection computing system 240 can identify a format of the record (i.e., the record is defined as the data representing an un-encrypted patient identifier and the health information requested for the patient) and utilize one or more business rules specific to the identified format to parse the record and identify the PII. In some implementations, the record of health information or healthcare data may be divided into various fields. Certain fields contained in the record may be of easily identifiable type and format. For example, the record of health data may include first and last name fields, a gender field, a date of birth field, an address field, a physician's name field, and one or more diagnosis fields. These easily identified types of fields may conform to a specific format or rely upon a set of selectable values. Other fields contained in the record may be more difficult to easily classify without knowledge of the record's format. For example, the record of health data may contain one or more text fields that permit a user to enter text in any format. These text fields may include, for example, treatment fields and/or notes fields.

Specific sources of health data records may format records to include a specific set of data fields. In some implementations, these specific sources of records may provide information about the format they utilize for their healthcare data records. Additionally or alternatively, in some implementations, a user or administrator of the secure patient record transfer system 200 may review healthcare data records received from these specific sources to analyze and classify the general format of these records. Regardless of the source of formatting information, the secure patient record transfer system 200 may be configured to utilize record formatting information along with information about laws, regulations, and rules regarding the protection of PII to designate various portions of a health data record as PII.

In some implementations, the collection computing system 240 can include an extraction and encryption module 116 (e.g., as shown in FIG. 1) that may be configured to standardize and format part or all of the health information contained in the received data (e.g., data received at step 402). For example, the extraction and encryption module 116 may be configured to convert part or all of the data contained in the received data to UTF-8 format. In another example, the extraction and encryption module 116 may be configured to standardize fields within the healthcare data (e.g., converting text to upper-case).

Moreover, as part of identifying and extracting PII, the extraction and encryption module 116 may be configured to convert certain values to formats that conform with certain rules and regulations governing the handling of PII. For example, in some implementations, the extraction and encryption module 116 may be configured to convert a date of birth contained in the accessed record to an age group so as to obfuscate the actual birth date.

Additionally, as part of identifying PII, the extraction and encryption module 116 may be configured to identify the type and content of the PII included in the data record. In some implementations, for example, the extraction and encryption module 116 may utilize information regarding the overall format of the health data record to determine the location of a certain PII in the health data record. With information concerning the potential location of PII, the extraction and encryption module 116 may be configured to determine the type of PII actually present in the record and whether the content of the PII is valid. For example, a health data record may include fields for first and last name. The extraction and encryption module 116 may be configured to utilize information regarding the presence and location of the first and last name fields to determine whether the field includes any data (i.e., whether the field is blank) and whether data contained in the field may be a valid first and last name. For example, valid data contained in first and last name fields usually does not contain numbers or certain special characters. Therefore, extraction and encryption module 116 may be configured to analyze the data contained in the first and last name fields to determine whether the data contains any of these impermissible characters, and, if so, designate the data as invalid. In some implementations, the secure patient record accessing system 200 only utilizes valid PII for creating the hashed tokens as described in greater detail below.

In some implementations, when the extraction and encryption module 116 extracts PII from the health data record, the extraction and encryption module 116 can create a copy of the extracted PII, while leaving the PII in the healthcare data record. Alternatively, when the extraction and encryption module 116 extracts PII from the received health data record, the extraction and encryption module 116 removes the extracted PII from the healthcare data record. In some implementations, the extraction and encryption module 116 utilizes one or more business rules to determine which portions of PII to extract from the health data record. The business rules may be specific to a geographic region, a type or other classification of the health data record, or the source of the healthcare data record. For example, the business rules may indicate that the laws, rules, or regulations associated with a first geographic region allow certain data that would be considered PII in a second, different geographic region to remain included in a health data record. The identification of the type and content of the PII included in the health data record may happen before, during, or after the extraction of the PII from the health data record.

The extraction and encryption module 116 can be configured to encrypt certain portions of the PII. In some implementations, the extraction and encryption module 116 is configured to encrypt each portion of extracted PII individually. In some implementations, the extraction and encryption module 116 may be configured to encrypt a combination of extracted portions of PII. For example, the extraction and encryption module 116 may encrypt a first letter contained in a first name field of a health data record and the entire last name contained in a last name field. In another example, the extraction and encryption module 116 may wait to encrypt the extracted portions of PII until after the creation of one or more strings of the PII. The extraction and encryption module 116 may utilize any suitable encryption algorithm or method to encrypt the extract portions of PII. For example, the extraction and encryption module 116 may utilize key-based encryption (e.g., RSA, DSA, or AES), hash function, or any other suitable encryption method. In some implementations, for example, the extraction and encryption module 116 may encrypt one or more of the extracted portions of PII using AES-128.

In some implementations, the collection computing system 240 can also include a concatenation and hashing module 118 (as shown in FIG. 1) that concatenates multiple portions of the extracted PII into a specific number of strings. Ultimately, the concatenation and hashing module 118 creates one or more hashed tokens that may be used by the collection computing system 240 to link de-identified healthcare data records (as discussed in greater detail in step 416). However, the number of hashed tokens may be varied based on a number of different factors. Thus, in some implementations, the concatenation and hashing module 118 is configured to utilize the analysis of the PII contained in the health data record performed by the extraction and encryption module 116 in conjunction with one or more business rules to determine how many concatenated strings of extracted PII (and ultimately hashed tokens) to create.

In some implementations, the one or more business rules utilized by the concatenation and hashing module 118 may be specific to a geographic region. Thus, depending on a geographic region associated with the healthcare data record and/or the secure patient record accessing system 200, the one or more business rules may indicate that a certain number of strings of extracted PII should be created. Additionally or alternatively, the one or more business rules may indicate that the laws, rules, or regulations associated with a geographic region require that healthcare data records always include certain PII. As a result, the one or more business rules may indicate that the number of strings of extracted PII can be fewer, since all healthcare data records within the region will uniformly include a certain amount of PII, making it more likely that the created hashed tokens can be used to accurately link de-identified records.

In some implementations, the one or more business rules by the concatenation and hashing module 118 may define a relationship between the amount, type, and content of PII included in a health data record and the number of strings of extracted PII to be created. For example, certain PII (e.g., social security number or healthcare insurance number) is very accurate in identifying a person, while other PII (e.g., zip code or age group) are unlikely to uniquely identify an individual, though they may be useful in narrowing a potential group of matching persons. The greater the amount of PII that is included in a health data record, the more likely that two healthcare data records with the same PII are matches. Unfortunately, given the great number of possible sources of health data records and the great number of potential formats a health data record might take, the amount of PII included in any one health data record may vary. Moreover, where a health data record only includes (or regional laws, rules, or regulations only permit consideration of) PII that can narrow a group of potential persons but not uniquely identify them, it can be helpful to consider as much PII as possible to increase the statistical likelihood of matching two de-identified health data records. Accordingly, the amount, type, and content of PII included in a health data record may increase or decrease a number of strings to be generated in order to satisfy a statistical likelihood of matching de-identified patient records (in later steps).

The concatenation and hashing module 118 also utilizes one or more business rules to determine which extracted PII to include in each concatenated string and in which order. As with the number of concatenated strings to be created, the one or more business rules indicating the content and ordering of the strings of extracted PII are generally designed to increase the statistical likelihood that the resulting hashed tokens can be matched with hashed tokens associated with other health data records related to the same patient(s) or person(s). In one example, the concatenation and hashing module 118 may utilize the one or more business rules and the analysis of the PII performed by the extraction and encryption module 116 to determine that two strings should be created for a particular healthcare data record. The one or more business rules may indicate that a first string should include encrypted versions of the person's last name, date of birth, and zip code, and that a second string should include encrypted versions of the person's first name, last name, and insurance provider. The number of strings to be created and the ordering and content of the strings can be varied in any way.

The collection computing system 240 may perform the patient identity encryption process in many different ways. For example, the details of the one or more business rules relied upon in each operation may vary depending on a number of factors (e.g., geographic region, type of healthcare data record, details regarding the person(s) to whom the healthcare data record relates, etc.).

The concatenation and hashing module 118 of the collection computing system 240 can apply one or more hashing functions to each of the specific number of strings to create a corresponding number of hashed tokens. The number and type of hashing functions used by the concatenation and hashing module 118 to hash each of the concatenated strings of PII may vary. Moreover, in some instances, another cryptographic primitive, such as a block cipher, can be used instead of a hashing function. However, the hash function may be preferred because it generally has no inverse function that can recover the input from the hash function's output. A hash function maps a bit string of arbitrary length to another bit string of fixed length. Hash functions include Ripe-MD, Whirlpool, Haval, MD4, MD5, and the SHA group of hash functions. Preferably, the concatenation and hashing module 118 utilizes the SHA-2 family, in particular, SHA-256 which creates 256 bit hashes. The SHA family of hash functions was designed by the National Institute of Standards and Technology and is a Federal Information Processing Standard, as described by Federal Information Processing Standards Publication 180-2, dated Aug. 1, 2002. Federal Information Processing Standards Publication 180-2 also provides an algorithm and examples for implementing an SHA-256 hash function.

In some implementations, the concatenation and hashing module 118 of the collection computing system 240 may be configured to apply multiple hashing functions to each of the concatenated strings of PII. For example, in some implementations, the concatenation and hashing module 118 may, for each of the concatenated strings of PII, append a portion of an encryption key to the concatenated string. The concatenation and hashing module 118 may then create an intermediary token by applying a first hashing function (e.g., SHA-256) to the concatenated string with the appended portion of the encryption key. The concatenation and hashing module 118 may then append another portion of the encryption key to the intermediary token. The concatenation and hashing module 118 may then create a final hashed token by applying a second hashing function (e.g., SHA-256) to the intermediary token with the appended other portion of the encryption key.

Additionally, as shown in FIG. 1, the collection computing system 240 can also include a de-identification module 124 that de-identifies the accessed healthcare data record. In some implementations, the de-identification module 124 creates a copy of the received healthcare data record and de-identifies the copy. In other implementations, the de-identification module 124 directly de-identifies the received healthcare data record. To de-identify a healthcare data record, the de-identification module 124 removes data designated as PII from the healthcare data record. For example, regional laws, rules, and/or regulations may indicate that fields containing certain types of data should be designated as PII and handled accordingly. Though the designation and protection of PII by the secure patient record accessing system 200 is designed to conform to the applicable laws, rules, and regulations regarding PII, certain PII may still be contained in a record, even after removal of designated PII.

The collection computing system 240 can store the specific number of hashed tokens created with the healthcare data records de-identified. In some implementations, the collection computing system 240 can store the specific number of hashed tokens with the de-identified healthcare data record. In other implementations, the collection computing system 240 can store the specific number of hashed tokens separately from the de-identified healthcare data record and link them together through known linking techniques.

In some implementations, the collection computing system 240 can store a PII presence indicator along with either or both of the hashed tokens and the de-identified healthcare data record. The PII presence indicator indicates which types of PII are contained in each token. For example, one ore more business rules may indicate that a particular hashed token created for a record of health data should be based on the last name field, the postal code field, and the age field included in the record of healthcare data. However, the record of health data may not include the last name field or it may otherwise be determined to be invalid. In such an instance, the concatenation and hashing module 118 may be configured to use a preset NULL value in place of the last name field when creating the hashed token. In such a case the PII presence indicator will indicate that the last name field will indicate that the last name field was not present in the original record. The PII presence indicator may then be used, for example, by the patient linkage module 146 when attempting to link de-identified patient records.

Moreover, in some implementations, the collection computing system 240 can transmit the specific number of hashed tokens separately from the de-identified health data to another location or computer system. The collection computing system 240 may utilize any known forms of storage (e.g., RAM, ROM, optical drive, etc.), transmission method (e.g., e-mail, SFTP, etc.), and transmission medium (wired, wireless, etc.).

At 405, the collection computing system 240 can send the request for the (de-identified) health record information associated with the anonymized patient identifier (as represented by the hashed tokens described above) to the intermediate computing system 260. At 406a and 406b, the intermediate computing system 260 can receive periodic, substantially periodic or random updates of new anonymized identifiers of new patients and modified anonymized identifiers of existing patients sent from the source computing systems 210 and 230. The intermediate computing system 260 can store the updated anonymized identifiers of new and/or existing patients in a database or a table stored either in the intermediate computing system 260 or on a remote device that is operably coupled to the intermediate computing system 260.

At 407, the intermediate computing system 260 can match the received anonymized patient identifier with the stored anonymized patient identifiers that are received from the source computing systems 210 and 230. If one or multiple matches are found, the intermediate computing system 260 can identify the source computing systems 210 and 230 (from among all source computing systems in a network of healthcare institutions) corresponding to the match. Note that multiple matching strategies can be employed to match (or compare) the received anonymized patient identifier to the stored anonymized patient identifiers in the intermediate computing system 260. For example, in some instances, a match between the received anonymized patient identifier and the stored anonymized patient identifiers can exceed a pre-determined threshold (e.g., greater than or equal to an 80% match) to be considered an appropriate match.

At 408a and 408b, the intermediate computing system 260 sends the request for the de-identified patient data associated with the anonymized patient identifier to the source computing systems 210 and 230 based on the matching of the anonymized patient identifier received from the collection computing system 240 and the anonymized patient identifiers received and stored from the source computing systems 210 and 230. As described above, steps 407, 408a and 408b can be a computationally efficient and a time saving steps as the intermediate computing system 260 can send the request for de-identified patient data associated with the anonymized patient identifier to only a selected or defined subset of the source computing systems 210 and 230 from all the potentially existing source computing systems in the network of healthcare institutions.

The source computing system 210 and 230 can receive the request for the de-identified patient data associated with the anonymized patient identifier from the intermediate computing system 260 and perform a lookup operation on a database or a table stored either in the source computing devices 210 and 230 or operably coupled to the source computing devices 210 and 230. In such instances, the source computing systems 210 and 230 can match the anonymized patient identifier in the data received from the intermediate computer system 260 with a set of anonymized patient identifiers stored in the database in the source computing devices 210 and 230. If a match is found, the source computing devices 210 and 230 can retrieve the stored encrypted and de-identified patient data associated with the matched anonymized patient identifier. At 410a and 410b, the source computing system 210 and 230, respectively, can send the encrypted and de-identified patient data associated with the matched anonymized patient identifier to the intermediate computing system 260 (e.g., via the network 280). Such encrypted and de-identified patient data can include, for example, data associated with each prescription of the pharmaceutical product dispensed from the health services provider associated with the source computing system 210 and/or 230, a type of the pharmaceutical product prescribed, the location of the source computing system 210 and/or 230, the data and time a prescription was dispensed, an amount of the pharmaceutical product that was prescribed, the price of the pharmaceutical product prescribed, the dosage of the pharmaceutical product prescribed, and/or the like. Note that the health record or data requested (and sent) is not limited to prescriptions of pharmaceutical products. In other instances, the heath data requested can be, for example, but is not limited to, diagnoses, patient visit information, drug data, health procedure data, blood pressure readings, prescription specific information, laboratory data, data feeds, test orders, test results, consultant's report, and other similar data related to or associated with the health of the patient (or person).

After receiving the set of encrypted and de-identified patient data associated with the anonymized patient identifier from the source computing systems 210 and 230, the intermediate computing system 260 analyzes the set of encrypted and de-identified patient data to generate or define an encrypted and de-identified cumulative report. The analysis can involve, for example, determining, the validity of the encrypted and de-identified patient data received from each source computing system 210 and/or 230 from the set of source computing systems by, for example, analyzing a security token and a time stamp associated with the encrypted and de-identified patient data; longitudinally linking, the received encrypted and de-identified patient data associated with the anonymized patient identifier from one source computing system 210 or 230 from the set of source computing systems 210 and 230 to the received encrypted and de-identified patient data associated with the anonymized patient identifier from the other source computing systems 210 or 230 from the set of source computing systems; and aggregating, the longitudinally linked encrypted and de-identified patient data associating with the anonymized patient identifier from the set of source computing systems 210 and 230. The aggregation process can provide a robust tabulation of the different entries in the encrypted and de-identified cumulative report in response to the request for health record information associated with the anonymized patient identifier. For example, in some instances, the aggregation process can list the different pharmaceutical products (e.g., drug A, drug B, drug C, drug D, etc.) prescribed to the patient associated with the anonymized patient identifier at different times by each source computing system 210 or 230 from the set of source computing systems 210 and 230 in the encrypted and de-identified cumulative report.

At 414, the intermediate computing system 260 sends the de-identified and encrypted cumulative report to the collection computing system 240. At 416, after receiving the de-identified and encrypted cumulative report from the intermediate computing system 260, the collection computing system 240 can decrypt and analyze the encrypted and de-identified cumulative report to generate or define a decrypted cumulative report and the (re-identified) patient identifier information (PII) associated with the patient, respectively. For example, in some instances, the decrypted cumulative report can be a list of known drugs prescribed to the patient associated with the de-identified patient identifier in a defined time period. The contents of the cumulative report can be customized to the requirements of the healthcare institution associated with the collection computing system 240. For example, the report can include how often a certain medical procedure was completed in a certain city, the demographic data associated with prescriptions of a certain class of drugs, and other similar data. The cumulative report can be, but is not limited to, a paper report, electronic data, a data feed, a program, or any other suitable output. The collection computing system 240 can create a report with a predetermined form and format.

The collection computing system 240 can link the decrypted cumulative report with the PII in response to the request for health record information for the patient. The cumulative report can assist a healthcare professional make a decision about a request for, for example, a medical service and/or a pharmaceutical product. For example, in some instances, the decision can be whether to allow the healthcare professional at the healthcare institution associated with the collection computing system 260 to fill a prescription for a drug for the patient on a given day. At 418, the collection computing system 240 can send the linked and decrypted cumulative report in response to the request for health record information for the patient to the to the transaction computer system that originated the request, and data representing the linked cumulative report can be stored at the collection computing system 240 and/or the transaction computer system.

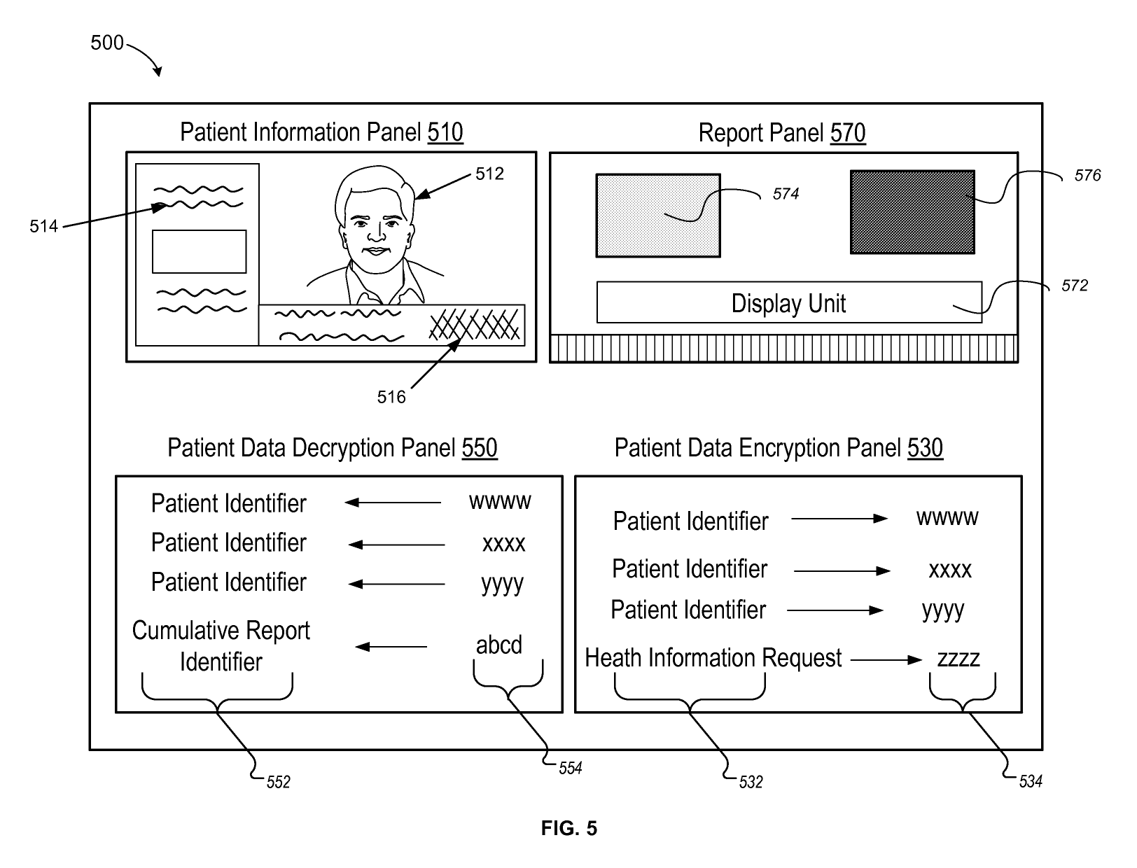

FIG. 5 is a block diagram of an example graphical user interface that may be used for sending a request for patient health record information and receiving encrypted and de-identified patient data. The graphical user interface (GUI) 500 shown in FIG. 5 can be implemented on one or more computing devices associated with the collection computing system 240. The graphical user interface (GUI) 500 can be generated by a user application (not shown in FIGS. 1-5) that can be part of and/or include a hardware module(s) and/or a software module(s) stored in the memory and/or executed in a processor of a computing device that controls input from and/or output to a display unit (not shown in FIG. 5). The display unit can be, for example, a liquid crystal display (LCD) unit or a light emitting diode (LED) alpha-numeric display unit that can display a graphical user interface (GUI). The GUI 500 displayed can allow a user to interact with computing devices associated with the collection computing system 240 to send request(s) for patient health record information and receive encrypted and de-identified patient data. The GUI 500 may include a set of displays having message areas, interactive fields, pop-up windows, pull-down lists, notification areas, and buttons that can be operated by the user. The GUI 500 may include multiple levels of abstraction including groupings and boundaries. It should be noted that the term “GUI” may be used in the singular or in the plural to describe one or more GUI's, and each of the displays of a particular GUI may provide the user with a user-friendly interactive environment to sending request for patient health record information and receiving encrypted and de-identified patient data.

The GUI environment enables users to author their compositions through the GUI 500. In this context, a composition may comprise a graphical template, which can include two-dimensional (2D) and two-dimensional (3D) geometries, typographical fonts, images, audio clips, video clips, or any suitable combination of these. Any of these elements may be either animated or static. The GUI 500 includes one or more panels, such as a patient information panel 510, a patient data encryption panel 530, a patient data decryption panel 550, and a report panel 570. Each panel may include multiple user interface elements.

The patient information panel 510 can include a patient photograph 512, one or more patient identifying information (PII) 514 (e.g., the patient name, element of addresses, birth date, social security number, insurance policy number, and/or driver's license number, etc.), and data associated with the request for patient health information 516 (e.g., a name of a pharmaceutical product, medical device, or a treatment procedure requested, the date of the request, an identifier of a healthcare professional (e.g., a doctor) that prescribed the medical service, etc.).

The patient data encryption panel 530 displays a list of patient identifiers (PII) 532 that is used be used to generate an anonymized patient identifier. The patient identifiers can be accessed from the data represented in the patient information panel 510. As described above, the collection computing system 240 can identify and extract multiple portions of PII included in data represented in the patient information panel 510. In some implementations, the collection computing system 240 can identify a format of the record (i.e., the record is defined as the data representing the PII and the health information requested for the patient as shown in the patient information panel 510) and utilize one or more business rules specific to the identified format to parse the record and identify the PII. In some implementations, the health record information or healthcare data may be divided into various fields such as, for example, a first and last name fields, a gender field, a date of birth field, an address field, a physician's name field, and one or more diagnosis fields that can be used by the collection computing system 240 to generate the anonymized patient identifiers as described in FIG. 4. The patient data encryption panel 530 also display the de-identified data associated with the health information request 530 that is to be encrypted before sending the encrypted request for health record information to the intermediate computing device 260. The data associated with the health record information request for a patient can include, for example, a name of a pharmaceutical product, medical device, or a treatment procedure requested, the date of the request, an identifier of a healthcare professional (e.g., a doctor) that prescribed the medical service, and/or the like. The patient data encryption panel 530 can display entries that are representative of a list of hashed tokens 534 of the anonymized patient identifier and/or the encrypted data associated with the request health record information (e.g., represented by ‘wwww’, ‘xxxx’, ‘yyyy’ shown in FIG. 5). The patient data encryption panel 530 can also display entries that are representative of a list of hashed tokens 534 of the specifics of the health record information request (e.g., represented by ‘zzzz’ as shown in FIG. 5). Note that the actual hashed token strings are stored in a database in the collection computing system 240 are not displayed in the patient data encryption panel 530 for security reasons. The displayed entries marked 534 are indicators to the actual hashed token strings and not the actual hashed token strings themselves.

The patient data decryption panel 550 displays a set of patient data that have been decrypted 552 after being received from the intermediate computing system 260. Such data 552 can include, for example, the patient identifiers re-identified from the set or series of hashed tokens that represented the anonymized patient identifiers and the decrypted version of the cumulative report generated by the intermediate computing device 260 in response to the request for patient health record information. The patient data decryption panel 550 displays an identifier for the cumulative report (e.g., a filename, a file ID, etc.) after the cumulative report has been decrypted and linked with the PII at the collection computing system 240. Additionally, the patient data decryption panel 550 also displays entries that are representative of the set of encrypted data 554 for the patient identifier and the cumulative report. Note that the actual hashed token strings are stored in a database in the collection computing system 240 are not displayed in the patient data decryption panel 550 for security reasons. The displayed entries marked 554 are indicators to the actual hashed token strings and not the actual hashed token strings themselves.

The report panel 570 includes a display unit 572 that displays information in response to the request for the health record information by the collection computing system 240 based on the cumulative report generated by the intermediate computing system 260. For example, in some instances, the information displayed in the display unit 572 can be related to how the healthcare professional at the healthcare institution associated with the collection computing system 260 will proceed with the patient's treatment. The report panel 570 also includes a set of indicators 574 and 576 that can flash based on the status of the cumulative report. In some instances, the indicator 574 can flash if the cumulative report in response to the request for health record information includes potentially problematic information (e.g., the Patient X's drug history has a risk score of 90%). In other instances, the indicator 576 can flash if the cumulative report in response to the request for health record information does not include any potentially problematic information (e.g., the Patient X's drug history has a risk score of 10%). Note that information displayed in the graphical user interface (GUI) 500 can include any types of patient healthcare information (and not restricted to drugs only) such as, for example, pharmaceutical products purchased, medical devices purchased, medical treatment procedures requested and/or received, results of laboratory tests performed, and/or the like.

The secure patient record transfer system described in FIGS. 1-5 focuses on the sharing of health record information (i.e., data) between healthcare institutions as an example only, and not a limitation. In other instances, the secure patient record transfer system described above can be used to share information with a patient or with a non-healthcare institution with the patient's consent. For example, the secure patient record transfer system described above can be used to enable a patient to download an integrated prescription record including data from all of the pharmacies the patient has used. An example of the use of the secure patient record transfer system to provide information to a non-healthcare third party would be the provision of a patient's health records to an organization with the patient's consent for underwriting a life insurance policy.

The secure patient record transfer system described in FIGS. 1-5 can significantly reduce the risk associated with sending identifiable health information (e.g., PII) over the Internet and in creating shared databases of health information to enable data sharing. This is because systems (e.g., databases) storing sensitive user such as health record information are susceptible to compromise from adversaries and/or hackers. In some instances, user passwords can be compromised that may reveal individual user sensitive data. In other instances, system security compromise may reveal multiple user sensitive data. Thus compromise of sensitive user data through loss, unauthorized access or theft can damage an organization's reputation and can lead to significant financial ramifications. By sending encrypted and de-identified patient data through the Internet and storing anonymized patient identifiers in different computing systems, the secure patient record transfer system described in FIGS. 1-5 can significantly reduce the risk of compromise of user (or patient) sensitive data (e.g., PII's). For example, if the data in the intermediate computing system 260 were hacked into by a hacker, the hacker will not be able to obtain or regenerate the PII's associated with the multitude of stored anonymized patient identifiers in the intermediate computing system 260. Additionally, the hacker will also not be able to decrypt any de-identified and encrypted patient data stored in the intermediate computing system 260.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A method comprising:
receiving, by an intermediate computing system, a request for health record information associated with an anonymized patient identifier generated by applying one or more business rules to patient identifying information (PII) of a patient, from a collection computing system;
receiving, by an intermediate computing system, periodic updates from a plurality of source computing systems comprising new anonymized identifiers of new patients and modified anonymized identifiers of existing patients.
storing, by the intermediate computing system, the periodic updates received from the plurality of source computing systems comprising new anonymized identifiers of new patients and modified anonymized identifiers of existing patients.
sending, from the intermediate computing system, the request for health record information associated with the anonymized patient identifier to a set of source computing systems selected from the plurality of source computing systems based on a matching of the received anonymized patient identifier in the request to the stored anonymized patient identifiers;
receiving, by the intermediate computing system, encrypted and de-identified patient data based on one or more business rules from the set of source computing systems to the patient associated with the anonymized patient identifier;
analyzing, by the intermediate computing system, the encrypted and de-identified patient data associated with the patient associated with the anonymized patient identifier from the set of source computing systems to generate an encrypted cumulative report in response to the request for health record information associated with the anonymized patient identifier; and
sending, from the intermediate computing system, the encrypted cumulative report in response to the request for health record information associated with the anonymized patient identifier, to the collection computing system to allow for linking of the encrypted cumulative report with the patient identifying information (PII) of the patient based on applying one or more business rules.

2. The method of claim 1, wherein receiving, by the intermediate computing system, the encrypted and de-identified patient data comprises:
longitudinally linking the received encrypted and de-identified patient data from one source computing system from the set of source computing systems to the received encrypted and de-identified patient data from the other source computing systems from the set of source computing systems.

3. The method of claim 1, wherein analyzing, by the intermediate computing system, the encrypted and de-identified patient data comprises:
determining the validity of the encrypted and de-identified patient data received from each source computing system from the set of source computing systems by analyzing a security token and a time stamp associated with the encrypted and de-identified patient data received from the set of source computing systems; and
aggregating a selection of the longitudinally linked encrypted and de-identified patient data to the patient associated with the anonymized patient identifier from the set of source computing systems.

4. The method of claim 1, wherein the one or more business rules are specific to one of a plurality of geographic regions, and business rules specific to at least two of the plurality of geographic regions indicate a different method of patient data encryption.

5. The method of claim 1, wherein sending the request for health record information to the set of source computing systems comprises determining, by the intermediate computing system, the access rights of the collection computing system to make the request for health record information associated with the anonymized patient identifier.

6. The method of claim 1, wherein sending the request for health record information to the set of source computing systems comprises determining, by the intermediate computing system, if consent is required to access the health record information associated with the anonymized patient identifier.

7. The method of claim 1, wherein sending the request for health record information to the set of source computing systems comprises determining, by the intermediate computing system, if consent has been provided to access the health record information associated with the anonymized patient identifier.

8. The method of claim 1, further comprising receiving, by the intermediate computing system, periodic updates from the collection computing system comprising new anonymized identifiers of new patients and modified anonymized identifiers of existing patients.

9. The method of claim 1, further comprising storing, by the intermediate computing system, the periodic updates received from the collection computing system comprising new anonymized identifiers of new patients and modified anonymized identifiers of existing patients.

10. The method of claim 1, wherein the intermediate computing system is associated with a third-party intermediary system that collects, analyzes and transmits encrypted and de-identified patient healthcare data.

11. A non-transitory computer storage medium encoded with a computer program, the program comprising instructions that when executed by one or more computers cause the one or more computers to perform operations comprising:
receiving, by an intermediate computing system, a request for health record information associated with an anonymized patient identifier generated by applying one or more business rules to patient identifying information (PII) of a patient, from a collection computing system;
receiving, by an intermediate computing system, periodic updates from a plurality of source computing systems comprising new anonymized identifiers of new patients and modified anonymized identifiers of existing patients.
storing, by the intermediate computing system, the periodic updates received from the plurality of source computing systems comprising new anonymized identifiers of new patients and modified anonymized identifiers of existing patients.
sending, from the intermediate computing system, the request for health record information associated with the anonymized patient identifier to a set of source computing systems from the plurality of source computing systems based on a matching of the received anonymized patient identifier in the request to the stored anonymized patient identifiers;
receiving, by the intermediate computing system, encrypted and de-identified patient data based on one or more business rules from the set of source computing systems to the patient associated with the anonymized patient identifier;
analyzing, by the intermediate computing system, the encrypted and de-identified patient data associated with the patient associated with the anonymized patient identifier from the set of source computing systems to generate an encrypted cumulative report in response to the request for health record information associated with the anonymized patient identifier; and
sending, from the intermediate computing system, the encrypted cumulative report in response to the request for health record information associated with the anonymized patient identifier, to the collection computing system to allow for linking of the encrypted cumulative report with the patient identifying information (PII) of the patient based on applying one or more business rules.

12. The non-transitory computer storage medium of claim 11, wherein receiving the encrypted and de-identified patient data comprises:
longitudinally linking the received encrypted patient data associated with prescriptions of a pharmaceutical product from one source computing system from the set of source computing systems to the received encrypted patient data associated with prescriptions of a pharmaceutical product from the other source computing systems from the set of source computing systems.

13. The non-transitory computer storage medium of claim 11, wherein analyzing the encrypted and de-identified patient data comprises:
determining the validity of the encrypted and de-identified patient data received from each source computing system from the set of source computing systems by analyzing a security token and a time stamp associated with the encrypted and de-identified patient data received from the set of source computing systems; and
aggregating a selection of the longitudinally linked encrypted and de-identified patient data to the patient associated with the anonymized patient identifier from the set of source computing systems.

14. The non-transitory computer storage medium of claim 11, wherein the one or more business rules are specific to one of a plurality of geographic regions, and business rules specific to at least two of the plurality of geographic regions indicate a different method of patient data encryption.

15. The non-transitory computer storage medium of claim 11, wherein the program further comprising instructions that when executed by the one or more computers causes the one or more computers to send the request for health record information to the set of source computing systems based on determining, by the intermediate computing system, the access rights of the collection computing system to make the request for health record information associated with the anonymized patient identifier.

16. The non-transitory computer storage medium of claim 11, wherein the program further comprising instructions that when executed by the one or more computers causes the one or more computers to send the request for health record information to the set of source computing systems based on determining, by the intermediate computing system, if consent is required to access the health record information associated with the anonymized patient identifier.

17. The non-transitory computer storage medium of claim 11, wherein the program further comprising instructions that when executed by the one or more computers causes the one or more computers to send the request for health record information to the set of source computing systems based on determining, by the intermediate computing system if consent has been provided to access the health record information associated with the anonymized patient identifier.

18. The non-transitory computer storage medium of claim 11, wherein the program further comprising instructions that when executed by the one or more computers causes the one or more computers to receive, by the intermediate computing system, periodic updates from the collection computing system comprising new anonymized identifiers of new patients and modified anonymized identifiers of existing patients.

19. The non-transitory computer storage medium of claim 11, wherein the program further comprising instructions that when executed by the one or more computers causes the one or more computers to store, by the intermediate computing system, the periodic updates received from the collection computing system comprising new anonymized identifiers of new patients and modified anonymized identifiers of existing patients.

20. The non-transitory computer storage medium of claim 11, wherein the intermediate computing system is associated with a third-party intermediary system that collects, analyzes, and transmits encrypted and de-identified patient healthcare data.
